(19) United States
(12) Patent Application Publication
(10) Pub. No.: US 2022/0111657 A1
(43) Pub. Date: Apr. 14, 2022

(54) PRINT SUBSTANCE CONTAINERS

(71) Applicant: Hewlett-Packard Development Company, L.P., Spring, TX (US)

(72) Inventors: Kenneth Williams, Vancouver, WA (US); Tyler Kapp, Vancouver, WA (US); Tobias Martin, Vancouver, WA (US)

(73) Assignee: Hewlett-Packard Development Company, L.P., Spring, TX (US)

(21) Appl. No.: 17/266,003

(22) PCT Filed: Nov. 14, 2018
(86) PCT No.: PCT/US2018/061042

§ 371 Date: Feb. 4, 2021

(51) Int. Cl. B41J 2/175

(52) U.S. Cl. CPC B41J 2/17566; B41J 2002/17579; B41J 2/17513; B41J 2/17546

(57) ABSTRACT

A print substance container includes a print substance reservoir, a flange, and sensor system. The print substance reservoir includes a set of walls including an upstanding wall and a base. The set of walls enclose an interior of the print substance reservoir. The flange is remote from the interior of the print substance reservoir. The sensor system includes a level sensor, a reference full sensor, and a reference empty sensor. The level sensor is attached to the upstanding wall opposite the interior of the print substance reservoir. The reference full sensor is attached to the base opposite the interior of the print substance reservoir. The reference empty sensor is attached to the flange.

### BACKGROUND

Printing devices can include printers, copiers, fax machines, multifunction devices including additional scanning, copying, and finishing functions, all-in-one devices, or other devices such as pad printers to print images on three dimensional objects and three-dimensional printers (additive manufacturing devices). In general, printing devices apply a print substance often in a subtractive color space or black to a medium via a device component generally referred to as a print head. For example, printing devices that print in color mode may include supplies of subtractive color print substances such as cyan, yellow, magenta, and black or spot colors and printing devices that print in greyscale or monochromatic mode can include supplies of print substances such as black or a spot color. A medium can include various types of print media, such as plain paper, photo paper, polymeric substrates and can include any suitable object or materials to which a print substance from a printing device are applied including materials, such as powdered build materials, for forming three-dimensional articles. Print substances, such as printing agents, marking agents, and colorants, can include toner, liquid inks, or other suitable marking material that in some examples may be mixed with other print substances such as fusing agents, detailing agents, or other materials and can be applied to the medium. Printing devices can include a print substance container, which can include a refillable print substance container, to hold a print substance.

### BRIEF DESCRIPTION OF THE DRAWINGS

FIG. 1 is cross-sectional side-view schematic diagram illustrating an example print substance container.

FIG. 2 is a block diagram illustrating an example printing device to implement the example print substance container of FIG. 1.

FIG. 3 is a side-view schematic diagram illustrating an example print substance container constructed in accordance with the example print substance container of FIG. 1, which can be included in the example printing device of FIG. 2.

FIG. 4 is a plan-view schematic diagram illustrating an example print substance container constructed in accordance with the example print substance container of FIG. 1, which can be included in the example printing device of FIG. 2.

### DETAILED DESCRIPTION

Printing devices with a continuous print substance supply system, such as continuous ink supply systems, include print substance containers having print substance reservoirs to store print substance for use with the print head. The print substance reservoirs are generally filled with print substance from a print substance supply at the discretion of the user. Users can determine an amount of print substance to provide to the print substance reservoir and a frequency to provide the print substance to the print substance reservoir. In general, the print substance reservoir includes an upper fill level to indicate when the print substance reservoir is full of print substance and a lower fill level to indicate when the print substance reservoir is sufficiently devoid of print substance, such as empty. Print substance can be provided to the print substance reservoir, such as when the print substance reservoir is sufficiently devoid of print substance, up to the upper fill level.

Printing devices employ level sensors to determine the level, such as height or amount, of the print substance in the print substance reservoir. Based on information obtained from the level sensor, printing devices can determine information such as how much print substance remains in the print substance reservoir and how much print substance has been added to the print substance reservoir when filled. Level sensors deployed in the print substance reservoir that contact the print substance can often accurately detect the amount of print substance, but the sensor structures can introduce sources of leaks, contamination, and corrosion into the print substance reservoir. Level sensors have been developed to continuously detect the amount of print substance from outside the print substance reservoir by measuring the capacitance of the interior of the print substance reservoir. Such sensors are affected by environmental changes such as temperature and humidity that degrade accuracy. For example, the dielectric materials of air and print substance proximate the level sensors may remain constant as the level of the print substance remains unchanged, but the dielectric properties of the air, print substance, or both may change due to temperature changes or other environmental effects, which results in changes to the measured capacitance that can lead to inaccurate determinations of the level of the print substance. Attempts to mitigate such environmental effects can result in sensor systems that are less accurate to changes in level of the print substance, which can affect the precision of the sensor.

This disclosure describes printing devices having print substance containers with level sensor systems that do not contact the print substance to determine the level of print substance within a print substance reservoir. In one example, the level sensor systems include a set of adjacent plate capacitor sensors that can continuously detect the level of the print substance within the print substance reservoir and can compensate for environmental affects that are often associated with sensors using adjacent plate capacitors. The sensors in the level sensor systems are deployed on the print substance containers in such a way as to increase sensitivity and precision of the level measurement over traditional capacitance sensor systems. An example configuration of the print substance container permits for the use of longer adjacent plate capacitors that serve to enhance accuracy but still conserve space or profile height of the print substance container.

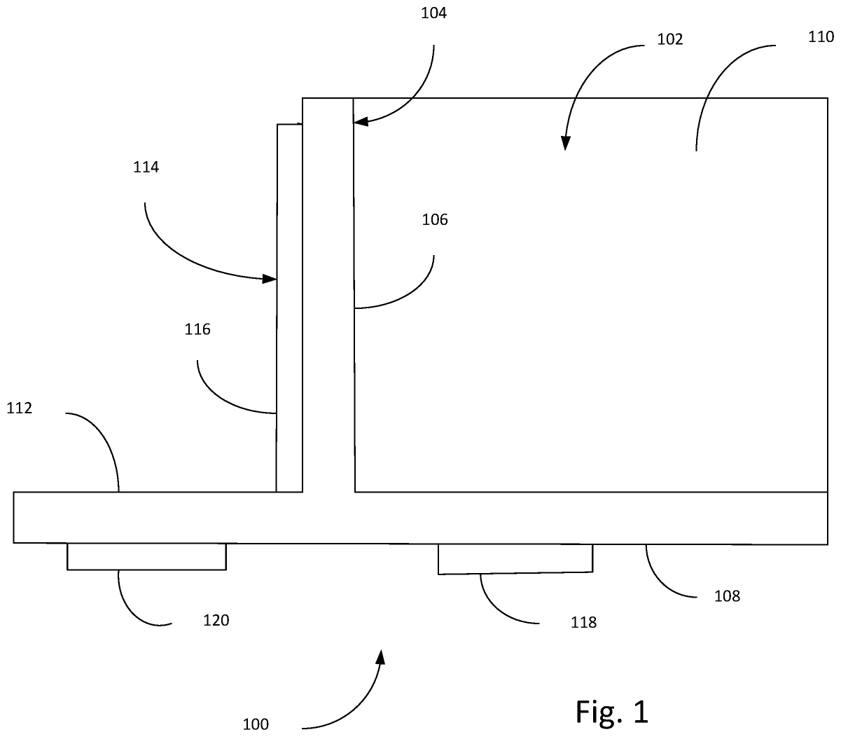

FIG. 1 illustrates an example print substance container 100, which can be installed or integrally formed in a printing device. The print substance container 100 includes a print substance reservoir 102 having a plurality of walls 104. The plurality of walls 104 includes an upstanding wall 106 and a base 108. In one example, the upstanding wall 106 and the base 108 are generally planar, and the upstanding wall 106 and base 108 are in intersecting planes. For example, the upstanding wall 106 can be generally orthogonal to the base 108. The upstanding wall 106 and base 108 can be constructed from a dielectric material, such as material that is capable of transmitting electric field without conduction. The plurality of walls 104 encloses an interior 110 of the print substance reservoir 102. A print substance can be contained within the interior 110 of the print substance reservoir 102. As the print substance is consumed, such as via printing, an amount of print substance within the print substance reservoir 102 decreases. Also, as print substance is added to the print substance reservoir 102, the amount of print substance within the print substance reservoir 102 increases.

The level of print substance, or a relative amount of print substance, within the interior 110 of the print substance reservoir 102 can be determined from a height of the print substance within the interior 110 of the print substance reservoir 102. In one example, the level of the print substance can be determined with respect to the upstanding wall 106. In one example, the upstanding wall 106 includes a length, such as a length from the base 108, and the height of the print substance with respect to the upstanding wall 106 varies along the length as the amount of the print substance within the interior 110 of the print substance reservoir 102 is added or consumed. For example, as print substance is added to the print substance reservoir 102, the height of print substance within the interior 110 of the print substance reservoir 102 will increase along the length of the upstanding wall 106 from the base 108, or become further distal from the base 108. As the print substance in the print substance reservoir 102 is consumed, the height of the print substance within the interior 110 of the print substance reservoir 102 will decrease along the length of the upstanding wall 106 from the base 108, or approach the base 108.

The print substance container 100 can also include a flange 112, which is a structure that is remote from the interior 110 of the print substance reservoir 102. In one example, the flange 112 is generally planar and extends from the print substance reservoir 102. For example, the flange 112 can be formed coplanar with the base 108. The flange 112 can be attached to the print substance reservoir 102 either directly or via an intermediary structure.

The print substance container 100 includes a sensor system 114. The sensor system 114 includes a plurality of sensors that are configured to provide signals that can be processed to determine the level of the print substance within the interior 110 of the print substance reservoir 102. The sensor system 114 includes a level sensor 116, a reference full sensor 118, and a reference empty sensor 120. The level sensor 116 is attached to the upstanding wall 106 opposite the interior 110 of the print substance reservoir 102. The reference full sensor 118 is attached to the base 108 opposite the interior 110 of the print substance reservoir 102. The reference empty sensor 120 is attached to the flange 112. For example, the reference empty sensor 120 can be remote from the interior 110 of the print substance reservoir 102. The reference full sensor 118 and the reference empty sensor 120, in one example, are generally orthogonal to the level sensor 116, and the reference full sensor 118 can be coplanar with the reference empty sensor 120.

Each of the sensors in the sensor system 114 can include an adjacent plate capacitor, such as a coplanar capacitor. Adjacent plate capacitors are characterized by a pair of adjacent and elongated electrodes that may be formed as thin conductor strips or traces on a printed circuit assembly. The fringing electric fields of the adjacent electrodes in the adjacent plate capacitor penetrate into the dielectric material that is proximate to the adjacent plate capacitor. The variation of the dielectric properties of the proximate dielectric materials affects the inter-electrode capacitance, or capacitance, of the adjacent plate capacitor. Changes in the dielectric properties of surrounding dielectric materials can be detected by measuring the changes to capacitance of the adjacent plate capacitor. For the purposes of this disclosure, the adjacent plate capacitor of each sensor generates an effective fringing field, which is an amount of the fringing electric field of the adjacent capacitor that can measurably affect changes to capacitance of the sensor. Changes to the dielectric materials outside of the effective fringing field do not measurably affect the capacitance of the sensor. In one example, the sensor system 114 is operably coupled to a capacitance detection circuit such as a capacitance-to-digital converter to detect the affected capacitance of each of the sensors.

The level sensor 116 is attached to the upstanding wall 106 such that the elongate electrodes of the adjacent plate capacitor extend along the length of the upstanding wall 106, and the capacitance of the level sensor 116 is affected by the level the of print substance within the interior 110 of the print substance reservoir 102. In one example, the length of the elongate electrodes of the level sensor 116 on the upstanding wall 106 extends from a selected minimum height of the print substance in the print substance reservoir 102, or lower fill level, to a selected maximum height of the print substance in the print substance reservoir 102, or upper fill level. In some examples, an amount of print substance can be considered to be at the selected upper fill level if the amount of print substance is less than a capacity of the print substance reservoir 102.

The effective fringing field of the level sensor 116 penetrates the upstanding wall 106 and the interior 110 of the print substance reservoir 102. As the print substance within the interior 110 of the print substance reservoir 102 is added or consumed, the dielectric properties of the interior 110 of the print substance reservoir 102 changes, and these changes affect the capacitance of the level sensor 116. For example, a ratio of air and print substance varies as the print substance within the interior of the reservoir 102 is added or consumed, and this ratio affects the capacitance of the level sensor 116. The capacitance of the level sensor 116 is measured to determine the level of the print substance against the upstanding wall 106 in the interior 110 of the print substance reservoir 102.

Environmental conditions can affect the dielectric properties of the air and print substance within the interior 110 of the print substance reservoir 102, which can also affect the capacitance measurement of the adjacent plate capacitor in the level sensor 116. Such environment conditions can include temperature and humidity. In order to allow a printing device to account for changes in the level of the print substance and not to changes in capacitance due to environmental conditions, the sensor system 114 employs the reference full sensor 118 and the reference empty sensor 120. The reference full sensor 118 can be employed to measure changes in environmental conditions of the print substance and simulate a capacitance of a print substance reservoir filled with print substance. The reference empty sensor 120 can be employed to measure changes in environmental conditions of the air and to simulate a capacitance of a print substance reservoir devoid of print substance. Level sensor 116 is operably coupled to reference full sensor 118 and reference empty sensor 120 to detect the level of the print substance in print substance reservoir 102.

An amount of print substance is retained in the print substance reservoir 102 proximate the base 108 and opposite the reference full sensor 118 such that the effective fringing field of the reference full sensor 118 remains immersed in print substance at the lower fill level. The amount of print substance retained in the print substance reservoir 102 proximate the base 108 opposite the reference full sensor 118 remains enough so that variations in the level of the print substance do not measurably affect the capacitance of the reference full sensor 118. In one example, the lower fill level is selected such that a sufficient amount of print substance remains within the print substance reservoir 102 proximate the base 108 to cover the effective fringing field of the reference full sensor 118. In one example, print substance between the upper fill level and lower fill level can be extracted from the print substance reservoir 102, and print substance cannot be extracted from the print substance reservoir 102 once the lower fill level is reached. The dielectric materials in the effective fringing field of the reference full sensor 118 includes the base 108 and the print substance in the print substance reservoir 102 and is generally constant.

The reference empty sensor 120 is disposed on the flange 112 such that the generated effective fringing field of the reference empty sensor 120 does extend into the print substance within the interior 110 of the print substance reservoir 102. In one example, the reference empty sensor 120 is attached to the flange 112 such that the generated effective fringing field does not extend into the interior 110 of the print substance reservoir 102. The dielectric material in the effective fringing field of the reference empty sensor 120 includes the flange 112 and air proximate the flange 112 and is also generally constant.

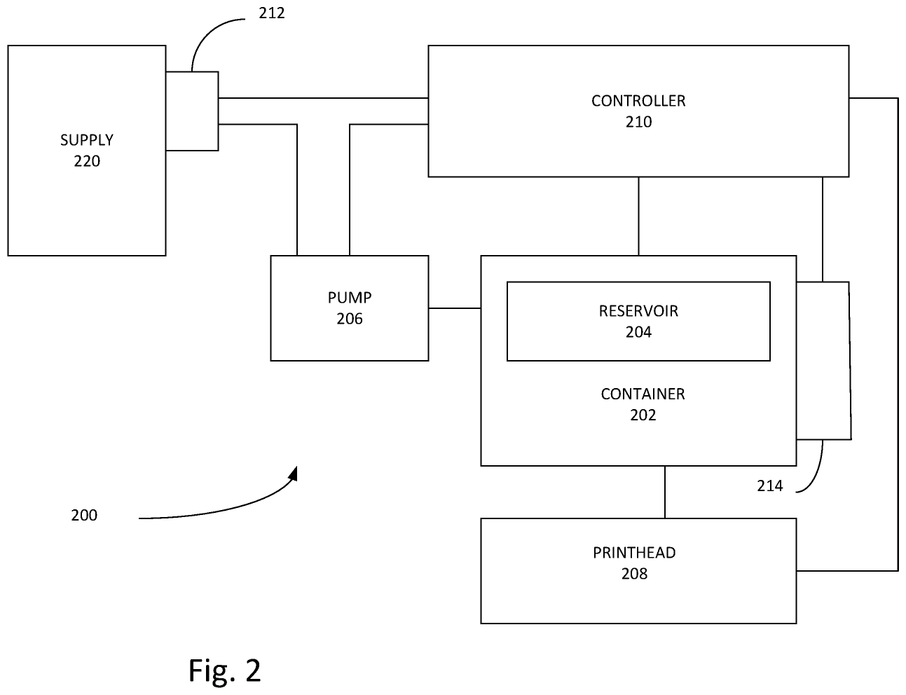

FIG. 2 illustrates an example printing device 200 that can implement example print substance container 100 and continuously detect a level of print substance via sensor system 114. The printing device 200 can be constructed to stand in an operating configuration, and may include a set of feet or rollers (not shown) that can interface with a support structure, such as a floor or table, or ground. The printing device 200 includes a print substance container 202 having a print substance reservoir 204. In one example, a pump 206 can provide a consumable print substance to the print substance reservoir 204. Print substance in the print substance reservoir 204 is delivered to a print head 208 for printing or marking on a medium. Examples of a print head 208 can include ink jet print heads that apply an incompressible fluid, such as a liquid, as the print substance and marking devices that apply particles of a toner as the print substance. Print substance reservoir 204 is in communication with channel 216 to receive print substance, and the print substance reservoir 204 is in communication with channel 218 to provide the print substance to the print head 208. The print substance container 202 includes sensor system 214, which can include a plurality of adjacent plate capacitors that can correspond with sensor system 114 and include a level sensor, a reference full sensor, and a reference empty sensor.

The pump 206, print head 208, and sensor system 214 are operably coupled to a controller 210. The controller 210 can include a combination of hardware and programming such as firmware stored on a memory device. The controller 210 can receive signals from the sensor system 214 to continuously determine a print substance level within the print substance reservoir 204 while the printing device is standing in the operating configuration. In one example, the sensor system 214 is operably coupled to a capacitance-to-digital converter that may be operably coupled to or included with the controller 210. The controller 210 can determine values associated with the signals provided from the sensor system 214 and resolve a level of the print substance in the print substance reservoir 204. From the determination of the level of the print substance, the controller 210 can further determine an amount of the print substance in the print substance reservoir 204. For example, the controller 210 can be configured to operate the pump 206 to provide providing print substance to the print substance reservoir 204 and to cease operation of the pump 206 once the upper fill level has been reached within the print substance reservoir 204 as determined by the sensor system 214. The controller 210 can also be configured to not provide print substance from the print substance reservoir 204 to the print head 208 once the lower fill level has been reached as determined by the sensor system 214. In another example, the channel 218 can be mechanically configured to stop extracting print substance from the print substance reservoir once the lower fill level has been reached within the print substance reservoir 204. Additionally, the controller 210 can be configured to select a sensitivity or precision of the capacitance measurement of the sensor system 214.

The printing device 200 can include one print substance container or multiple print substance containers. In some examples, the print substance container 202 can include multiple print substance reservoirs. In one example, the printing device 200 includes a print substance container 202 having a print substance reservoir, such as refillable print substance reservoir 204, for each color print substance of the printing device. The print substance container 202 provides the main storage of the print substance in the printing device 200. A printing device 200 in the subtractive color space can include a print substance reservoir to hold a cyan print substance, a print substance reservoir to hold a magenta print substance, a print substance reservoir to hold a yellow print substance, and a print substance reservoir to hold a black print substance. The printing device 200 may include other print substance reservoirs to hold other print substances such as photographic black, spot colors, or other colors used in the color space. In another example, the printing device 200 can implement a greyscale color space and the print substance reservoir 204 includes a black print substance. In one example, each print substance reservoir can be operably coupled to a corresponding pump, such as pump 206. Further, each print substance reservoir can be operably coupled to a print head, such as print head 208. In one example, each print substance reservoir can include a sensor system having a level sensor, a reference full sensor, and a reference empty sensor, or each print substance reservoir can include a level sensor and multiple print substance reservoirs can share a reference full sensor or a reference empty sensor.

The print substance reservoir 204 in one example is included with the printing device 200 and is distinguishable from a consumable cartridge that a user can readily remove and replace upon consumption of the print substance. In this example, the print substance reservoir 204 is a refillable reservoir. In the illustrated example, a supply vessel 220 is configured to be removably coupled to the printing device 200 to provide the print substance to the refillable print substance reservoir 204. The supply vessel 220 can include a supply output that is configured to be coupled to a print supply interface 212 of the printing device 200. In some examples, the print supply interface 212 can receives signals provided from a data structure located on the supply vessel 220 and can provide information regarding the print substance in the supply vessel 220 to the controller 210. The print supply interface 212 is operably coupled to the pump 206 to draw the print substance from the supply vessel 220 into the print substance reservoir 204 to store the print substance within the printing device 200 for use with the print head 208. In one example, the data structure may include information such as the amount of print substance remaining in the supply vessel 220 and type of print substance in the supply vessel 220. The controller 210 can receive the information and determine whether the print substance in the supply container 220 is compatible with a print substance intended to be included in the corresponding refillable reservoir 204. If the print substance in the supply container 220 is compatible with a print substance intended to be included in the corresponding refillable reservoir 204, the controller 210 can cause the pump 206 to draw print substance from the supply container 220 and provide the print substance to the print substance reservoir 204. In one example, the sensor system 214 and controller 210 can detect the amount of the print substance added to the print substance reservoir 204 and adjust the data regarding the amount of print substance remaining in the supply vessel on the data structure. The print substance may remain in the refillable reservoir 204 until the print substance is provided to the print head 208 for printing or marking on media.

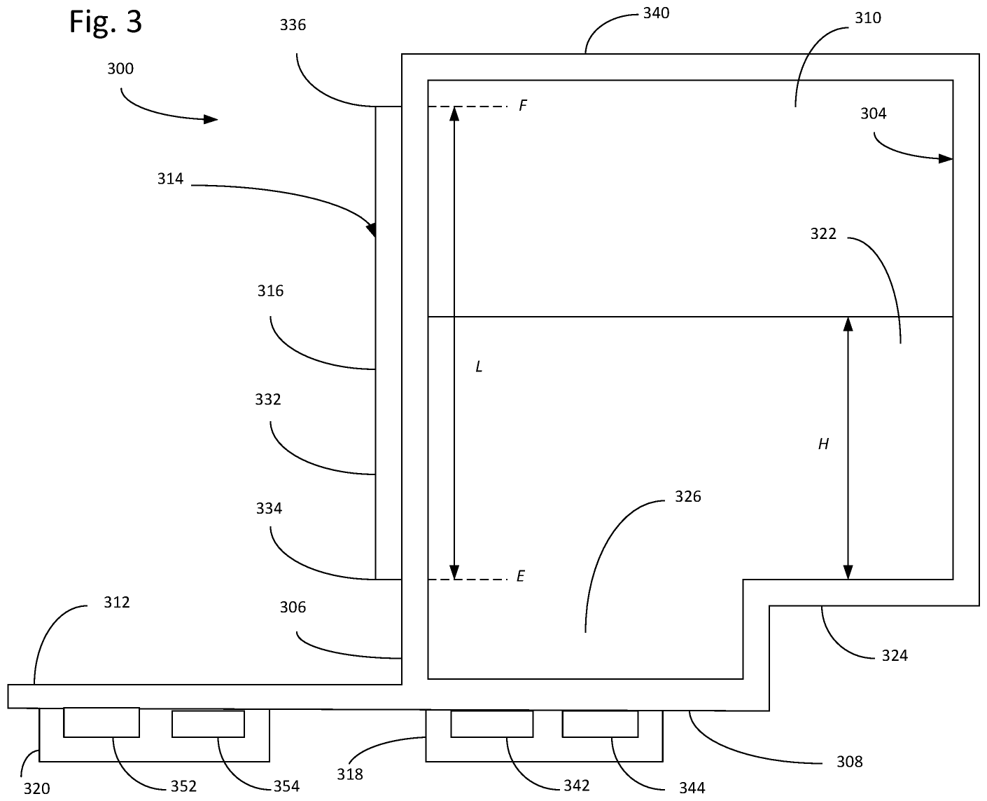

FIG. 3 illustrates an example schematic side view of print substance container 300 standing in the operating configuration and constructed in accordance with print substance container 100 and for use with printing device 200. Print substance container 300 includes a print substance reservoir 302 having a plurality of walls 304 including an upstanding wall 306 and a base 308. The plurality of walls 304 may also include a reservoir cover 340. In the example, the upstanding wall 306 includes a length and is generally perpendicular to the base 308. The plurality of walls 304 can surround a reservoir interior 310. A print substance 322 can be included within the reservoir interior 310. While the printing device 200 is standing in an operating configuration, the print substance 322 includes a height H along the length of the upstanding wall, and, as the print substance is added and consumed, the height H of the print substance 322 along the upstanding wall 306 can vary between an upper fill level F and a lower fill level E.

The print substance container 300 can include a flange 312, which is a structure that is remote from the reservoir interior 310. In one example, the flange 312 is generally planar and extends from the print substance reservoir 302. In the example, the flange 312 is coplanar with the base 308. In one example, the upstanding wall 306, base 308, and flange 312 are formed of a same dielectric material. In one example, thicknesses of the upstanding wall 306, base 308, and flange 312 are substantially the same. In one example, the width of the flange 312 can be greater than the width of the upstanding wall 306 or the width of the base 308 (the width of the upstanding wall 306, as well as the widths of the base 308 and of the flange 312, can be in the direction orthogonal to the length of the upstanding wall 306 in the plane of the upstanding wall 306).

The print substance container 300 also includes a sensor system 314, which can correspond with sensor system 114, to provide signals that can be processed to determine the level, or height H, of the print substance 322 within the reservoir interior 310. The sensor system 314 is configured to generally reduce the environmental effects that can skew a level determination based on a capacitance measured from just a level sensor.

The sensor system 314 includes a level sensor 316 attached to the upstanding wall 306 opposite the reservoir interior 310. The level sensor 316 includes an adjacent plate capacitor having a pair of elongate electrodes 332 of a length L. The electrodes 332 provide an effective fringing field into the reservoir interior 310, and the height H of the print substance 322 within the reservoir interior 310 affects the capacitance of the level sensor 316. The elongate electrodes 332 include a first end 334 proximate the base 308, and the first end 334 is at least as proximate the base 308 as a selected lower fill level E while the printing device 200 is standing in the operating configuration. The elongate electrodes 332 include a second end 336 distal from the base 308, and the second end 336 is at least as distal from the base 308 as a selected upper fill level F while the printing device 200 is standing in the operating configuration.

The sensor system 314 also includes a reference full sensor 318 attached to the base 308 opposite the reservoir interior 310. The reference full sensor 318 includes an adjacent plate capacitor having a first electrode 342 and a second electrode 344. The electrodes 342, 344 provide an effective fringing field into the reservoir interior 310, and the height H of the print substance 322 between the upper fill level F and the lower fill level E within the reservoir interior 310 does not measurably affect the capacitance of the reference full sensor 318. In one example, the reference full sensor can provide the controller 210 with a signal representative of the print substance reservoir 302 with print substance 322 filled to the upper fill level F subjected to environmental conditions.

In the example print substance reservoir 302, the plurality of walls 304 includes a bottom wall 324 that can intersect with the lower fill level E, be disposed between the lower fill level E and the base 308, or be coplanar with the lower fill level E. In one example, the bottom wall 324 is generally planar and in an intersecting plane with the upstanding wall 306, and, in this example, the bottom wall 324 may be in an intersecting plane with the base 308 (such as sloped toward the base 308) or may be in a parallel plane with the base 308. The bottom wall 324 and base 308 form a sump 326 proximate the base 308, or over the base 308 when the printing device is standing in the operating configuration and adjacent the bottom wall 324. The sump 326 can contain print substance 322 between the base 308 and the lower fill level E when the printing device 200 is standing in the operating configuration. In one example, the bottom wall 324 can be sloped toward the sump 326 to direct the print substance 322 into the sump 326. In one example, the print substance 322 in the sump 326 above the base 308 cannot be extracted from the print substance reservoir 302, such as via channel 218, and provided to the print head 208 while the printing device 200 is standing in the operating configuration. For instance, a print substance 322 can remain in the sump while a controller 210 indicates the print substance reservoir is empty. The sump 326 includes a depth between the base 308 and the lower fill level E. The depth is selected such that the effective fringing field from the reference full sensor 318 into the sump 326 is covered with enough print substance 322 that a varying height H of the print substance 322 will not measurably affect the capacitance of the reference full sensor 318. For example, the entire effective fringing field in the reservoir interior 310 generated by the reference full sensor 318 is contained within the sump 326. A sump 326 can be included to reduce the amount of print substance at the lower fill level E that remains in the print substance reservoir 302 to cover the reference full sensor 318.

The sensor system 314 further includes a reference empty sensor 320. The reference empty sensor 320 includes an adjacent plate capacitor having a first electrode 352 and a second electrode 354. The electrodes 352, 354 can provide an effective fringing field through the flange 312 and remote from the print substance 322 such that the height H of the print substance 322 within the reservoir interior 310 does not measurably affect the capacitance of the reference empty sensor 320. In one example, the reference empty sensor 320 can provide the controller 210 with a signal representative of the print substance reservoir 302 devoid of print substance or filled with print substance 322 at the lower fill level E subjected to environmental conditions. Level sensor 316 is operably coupled to reference full sensor 318 and reference empty sensor 320 to detect the level of the print substance in reservoir interior 310. In one example, the length of the reference empty sensor 320 can be greater than the width of the upstanding wall 306 or the width of the base 308. In one example, the reference full sensor 318 and reference empty sensor 320 can be constructed in the same printed circuit assembly and share a common non-conductive substrate of the printed circuit assembly. The printed circuit assembly can be attached to the print substance reservoir 302 at, for example, the base 308. The reference full sensor 318 and reference empty sensor 320 provided on the same substrate can be coplanar. In one example, the flange can include the non-conductive substrate

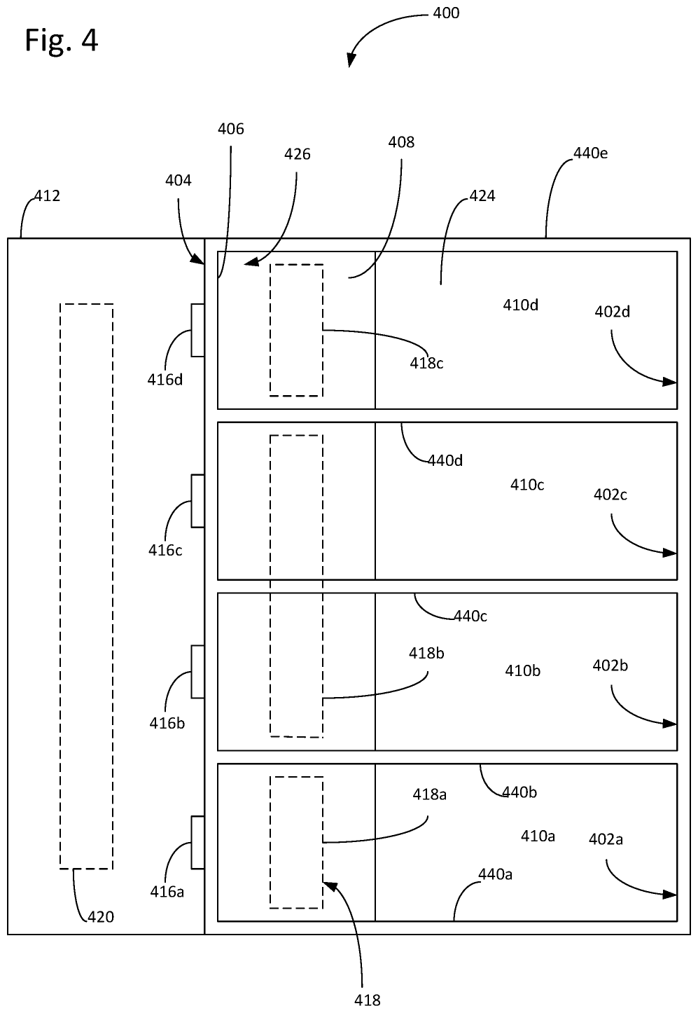

FIG. 4 illustrates an example schematic plan view of print substance container 400 constructed in accordance with print substance containers 300, 100 and configured for use with printing device 200. A reservoir cover, such as reservoir cover 340 of print substance container 300, has been removed from the example print substance container 400, and part of a sensor system 414 is illustrated in phantom. Print substance container 400 includes a plurality of print substance reservoirs 402a, 402b, 402c, 402d having a plurality of walls 404 including an upstanding wall 406 and a base 408. The plurality of walls 304 can also include a raised bottom wall 424 to form a sump 426 above the base 408. The sump 426 can include print substance below the lower fill level of each print substance reservoirs 402a, 402b, 402c, 402d. In the example, the upstanding wall 406 in the example is generally perpendicular to the base 408. The plurality of walls 404 can include surround a plurality of reservoir interiors 410a, 410b, 410c, 410d corresponding with print substance reservoirs 402a, 402b, 402c, 402d, respectively, and include side walls 440a, 440b, 440c, 440d, 440e. The print substance container 400 can include additional or fewer reservoir interiors and side walls. In the illustrated example, each print substance reservoir 402a, 402b, 402c, 402d can contain separate color print substance in the reservoir interior. 410a, 410b, 410c, 410d. For example, print substance reservoir 402a can include a yellow color print substance, print substance reservoir 402b can include a magenta color print substance, print substance reservoir 402c can include a cyan color print substance, and print substance reservoir 402d can include a black color print substance.

The print substance container 400 also includes a flange 412, which is a structure that is remote from the plurality of reservoir interiors 410a, 410b, 410c, 410d. In one example, the flange 412 is generally planar and extends from the plurality of print substance reservoirs 402a, 402b, 402c, 402d. In the example, the flange 412 is coplanar with the base 408. In one example, the upstanding wall 406, base 408, and flange 412 are formed of a same dielectric material. In one example, thicknesses of the upstanding wall 406, base 408, and flange 412 are substantially the same.

The sensor system 414 can detect the level of each of the print substances in the print substance reservoirs 402a, 402b, 402c, 402d independently. The sensor system 414 includes level sensors 416a, 416b, 416c, 416d each having an adjacent plate capacitor with a pair of elongate electrodes extending along the upstanding wall 406 opposite the corresponding reservoir interior 410a, 410b, 410c, 410d, respectively. Each of the level sensors 416a, 416b, 416c, 416d provides an effective fringing field into reservoir interior 410a, 410b, 410c, 410d, respectively, and the height of the print substance within each of the reservoir interiors 410a, 410b, 410c, 410d affects the capacitance of the corresponding level sensor 416a, 416b, 416c, 416d. The elongate electrodes extend from a selected lower fill level to a selected upper fill level while the printing device 200 is standing in the operating configuration.

The sensor system 414 also includes a reference full sensor 418 attached to the base 408 opposite the reservoir interiors 410a, 410b, 410c, 410d. The reference full sensor 418 includes an adjacent plate capacitor having elongate electrodes to provide an effective fringing field into the reservoir interiors 410a, 410b, 410c, 410d, such as into the sump 426 so that the height of print substance within each of the reservoir interiors 410a, 410b, 410c, 410d does not measurably affect the capacitance of the reference full sensor 418.

In the example, the sensor system 414 includes a plurality of reference full sensors 418a, 418b, 418c. Longer adjacent plate capacitors can provide more sensitivity than shorter adjacent plate capacitors. The adjacent plate capacitors are also affected by the dielectric properties of the print substances in the print substance reservoirs 402a, 402b, 402c, 402d. A single reference full sensor can be used for different print substances that have substantially the same dielectric properties. In the example, the print substance in reservoir interior 410a includes dielectric properties different than the print substances in the other reservoir interiors, 410b, 410c, 410d, and the elongate electrodes of the reference full sensor 418a are configured to extend between side wall 440a and side wall 440b along the width of the reservoir interior 410a to provide an effective fringing field into reservoir interior 410a. (In an alternate example, the elongate electrodes of the reference full sensor 418a can be configured to extend between the upstanding wall 406 and the bottom wall 424 on the base 408 opposite the reservoir interior 410a.) In the example, the print substances in reservoir interior 410b and reservoir interior 410c includes substantially similar dielectric properties, and reference full sensor 418b is configured to extend between side wall 440b and side wall 440d, and traverse side wall 440c along the widths of reservoir interiors 410b, 410c, to provide an effective fringing field into reservoir interiors 410b and 410c. In the example, the print substance in reservoir interior 410d includes dielectric properties different than the print substances in the other reservoir interiors, 410a, 410b, 410c, and reference full sensor 418c is configured to extend between side wall 440d and side wall 440e along the width of the reservoir interior 410d to provide an effective fringing field into reservoir interior 410d. (In an alternate example, the elongate electrodes of the reference full sensor 418c can be configured to extend between the upstanding wall 406 and the bottom wall 424 on the base 408 opposite the reservoir interior 410d.)

The sensor system 414 further includes a reference empty sensor 420. The reference empty sensor 420 includes an adjacent plate capacitor having a pair of electrodes that extend along the width of the flange 412. For example, the length of the adjacent plate capacitor of the reference empty sensor 420 can traverse the widths of several print substance reservoirs 402a, 402b, 402c, 402d. The long reference empty sensor 420 provides for additional sensitivity. The electrodes can provide an effective fringing field through the flange 412 and remote from the print substances such that the height of the print substance within the reservoir interiors 410a, 410b, 410c, 410d do not measurably affect the capacitance of the reference empty sensor 420.

In the example, each of the level sensors 416a, 416b, 416c, 416d are operably coupled to a common reference empty sensor 420. Level sensor 416a is operably coupled to reference full sensor 418a and reference empty sensor 420 to detect the level of the print substance in reservoir interior 410a. Level sensor 416b is operably coupled to reference full sensor 418b and reference empty sensor 420 to detect the level of the print substance in reservoir interior 410b. Level sensor 416c is operably coupled to reference full sensor 418b and reference empty sensor 420 to detect the level of the print substance in reservoir interior 410c. Level sensor 416d is operably coupled to reference full sensor 418c and reference empty sensor 420 to detect the level of the print substance in reservoir interior 410d.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A print substance container, comprising:
a print substance reservoir having a plurality of walls including an upstanding wall and a base, the plurality of walls to enclose an interior of the print substance reservoir;
a flange remote from the interior of the print substance reservoir; and
a sensor system including a level sensor attached to the upstanding wall opposite the interior of the print substance reservoir, a reference full sensor attached to the base opposite the interior of the print substance reservoir, and a reference empty sensor attached to the flange.

2. The print substance container of claim 1 wherein the plurality of walls and flange are formed of a same dielectric material.

3. The print substance container of claim 1 wherein the plurality of walls and flange have a same thickness.

4. The print substance container of claim 1 wherein the upstanding wall is generally orthogonal to the base.

5. The print substance container of claim 1 wherein the flange and base are generally coplanar.

6. The print substance container of claim 1 wherein the flange extends from the base.

7. The print substance container of claim 1 wherein the level sensor, reference full sensor, and reference empty sensor each include an adjacent plate capacitor.

8. The print substance container of claim 1 comprising a plurality of print substance reservoirs, wherein each print substance reservoir of the plurality of print substance reservoirs includes a corresponding level sensor.

9. The print substance container of claim 8 wherein each of the corresponding level sensors is operably coupled to a common reference empty sensor.

10. A print substance container, comprising:
a print substance reservoir having a plurality of walls including an upstanding wall and a base, the plurality of walls to enclose an interior of the print substance reservoir, the interior of the print substance reservoir including a sump proximate the base;
a flange remote from the interior of the print substance reservoir; and
a sensor system including a level sensor attached to the upstanding wall opposite the interior of the print substance reservoir, a reference full sensor attached to the base opposite the sump, and a reference empty sensor attached to the flange.

11. The print substance container of claim 10 including a bottom wall adjacent the sump.

12. The print substance container of claim 11 wherein the bottom wall is generally planar and in an intersecting plane with the upstanding wall.

13. The print substance container of claim 10 wherein the reference full sensor generates an effective fringing field in the interior of the print substance reservoir, and the sump includes a depth to include all of the effective fringing field in the interior of the print substance reservoir.

14. A printing device, comprising:
a print substance reservoir having a plurality of walls, the plurality of walls including an upstanding wall and a base, the plurality of walls to enclose an interior of the print substance reservoir; and
a level sensing system, including
a level sensor attached to the upstanding wall opposite the interior of the print substance reservoir;
a reference fill sensor attached to the base opposite the interior of the print substance reservoir; and
a reference empty sensor remote from the interior of the print substance reservoir.

15. The printing device of claim 14 comprising a controller having a capacitance-to-digital converter operably coupled to the level sensing system.
